(19) United States
(12) Patent Application Publication
(10) Pub. No.: US 2005/0170067 A1
(43) Pub. Date: Aug. 4, 2005

(54) Potassium pyrophosphate pet food palatability enhancers

(75) Inventors: Chen Chun Shao, Aurora, IL (US); Yasmine Stammer, Aurora, IL (US)

Correspondence Address: SYNNESTVEDT & LECHNER, LLP, 2600 ARAMARK TOWER, 1101 MARKET STREET, PHILADELPHIA, PA, 191072950, US

(73) Assignee: Bioproducts, Inc., Fairlawn, OH (US)

(21) Appl. No.: 10/770,751

(22) Filed: Feb. 3, 2004

(51) Int. Cl. A23L 1/31

(52) U.S. Cl. 426/646

(57) ABSTRACT

A palatability enhancing composition for extruded pet food containing at least one potassium pyrophosphate salt in an amount effective to enhance palatability and at least one ingredient selected from animal products, animal by-products, fish products, fish by-products, dairy products, dairy by-products, sources of microbial proteins, vegetable proteins, carbohydrates and amino acids. Methods for enhancing pet food palatability with the disclosed palatability enhancing compositions and extruded pet food compositions coated therewith are also disclosed.

### BACKGROUND OF THE INVENTION

This invention relates generally to a process and composition for improving the palatability of pet food. More particularly, this invention relates to a process and composition for improving pet food palatability with potassium pyrophosphate salts.

Desirable characteristics in pet food include high nutritional value, resistance to decomposition and bacterial contamination, low production costs, and a high degree of palatability. Pet food manufacturers strive to develop products that, on balance, optimize each of these characteristics. For certain products to be viable a high degree of palatability must be maintained; otherwise the animal would not consume the food. This is due primarily to the selectivity that some animals demonstrate in their choice of food. Domestic cats, in particular, are highly sensitive to food's palatability.

Pet food can be classified as one of three types: canned or high moisture products (generally consisting of greater than 50% moisture); intermediate moisture products (consisting of about 15% to 50% moisture); and dry or low moisture products (consisting of less than 15% moisture). Canned products are typically made from all meat or meat by-products and, as a result, achieve particularly high palatability. While animals often prefer these products, they tend to be more costly to produce and package. Compared to canned products, intermediate moisture products can be formulated with a higher nutritional value and can be manufactured at a lower cost. However, like canned products, intermediate moisture products are susceptible to microbial contamination and decomposition and, therefore, must be stabilized by preservatives. In contrast to canned and intermediate moisture products, dry products do not require preservatives. Dry products can also be formulated to achieve an exceptionally high nutritional value and are relatively inexpensive to produce and package. The physical characteristics of dry food allow it to be conveniently stored and used, thus leading to a general preference for this type of food among both pet food manufacturers and pet owners. However, dry food is commonly less appealing to animals due to its relatively low palatability. As previously stated, low palatability is a particular problem in developing cat food because of cats' pronounced selectiveness in choosing food.

Dry pet food products are usually produced as pellets or kibbles of various shapes and sizes. The palatability of dry pet foods can be improved by coating the surface of the food pieces with a palatability enhancer. Traditional palatability enhancers consist of flavorings including amino acids, fat, brewer's yeast, dried whey, and dry or liquid meat digest made from beef, pork, poultry, fish, etc. Other known palatability enhancers include phosphoric acid; a combination of fat with hexamic, phosphoric, or citric acid; and a mixture of phosphoric acid and citric acid. These acids may be used by themselves or in conjunction with a traditional palatability enhancer to further improve the traditional enhancer's palatability. For example, U.S. Pat. No. 3,139,342 (Linskey) demonstrates a process for enhancing the taste and/or nutritional value of dry pet food pellets by coating them with fat or vitamins. In U.S. Pat. No. 3,615,647 (Kassens), the palatability of a porous, expanded pet food in the form of chunks is improved by the application of a coating of fat overlaid with a coating of dextrin. The use of both a traditional enhancer along with an acidic enhancer is typically accomplished by a two-step coating process wherein a flavorant is first topically applied as a coating and then this coating is overlaid with a spray of acidic enhancer. U.S. Pat. No. 3,679,429 (Mohrman) discloses a method of improving palatability of dry cat food by coating food pellets with fat and an additional acidic enhancer. U.S. Pat. No. 3,930,031 (Kealy) is directed to a cat food composition that is coated with a mixture of phosphoric and citric acids to enhance palatability. U.S. Pat. No. 5,186,964 (Gierhart et al.) discloses the use of phosphate, pyrophosphate and polyphosphate palatability enhancers, optionally combined with citric, tartaric, fumaric, lactic, acetic, formic or hexamic acids, and a flavorant.

As noted in U.S. Pat. No. 4,215,149 (Majlinger), acid palatability enhancers generally accelerate the oxidation of fat, thereby leading to the fat's degradation. For this reason, the use of an acid palatability enhancer in combination with a topically applied traditional fat-based enhancer is limited. The solution to this problem, as demonstrated by Majlinger, is to coat the food pellets with a salt of phosphoric acid, specifically monosodium phosphate or sodium acid phosphate (SAP), in the range of 0.25% to 2.0% by weight.

Other improvements in palatability have been discussed in U.S. Pat. No. 6,254,920 (Brunner) and U.S. Pat. No. 6,350,485 (Brunner). The Brunner patents disclose the use of 0.1% - 99% by weight of tetrasodium pyrophosphate in palatability enhancer formulations.

Notwithstanding the known palatability enhancers, there remains a need for palatability enhancers that are more economic and convenient, yet maintain a high level of palatability.

### SUMMARY OF THE INVENTION

This need is met by the present invention. Extruded cat food compositions coated or otherwise formulated with palatability enhancing compositions containing potassium pyrophosphate salts derived from tetrapotassium pyrophosphate have been discovered to have a flavor preferred by cats.

Therefore, according to one aspect of the present invention, a method is provided in which a palatability enhancer containing at least one potassium pyrophosphate salt in an amount effective to enhance palatability is applied to an extruded pet food composition to increase palatability. Potassium pyrophosphate salts include mixed sodium and potassium salts. For purposes of the present invention “applied” is defined as including both adding at least one potassium pyrophosphate salt to a pet food formulation in an amount effective to enhance the palatability of the extruded composition prior to extrusion, as well as coating an extruded pet food composition with a palatability-enhancing quantity of at least one potassium pyrophosphate salt after the per food composition has been extruded.

Stated another way, the palatability enhancer, which preferably includes from about 0.1% to about 99% by weight of one or more potassium pyrophosphate salts, generally is topically applied to dry pet food pellets or kibbles, but may also be included as part of the basal formulation prior to extrusion. Other constituents of the palatability enhancer can include one or more ingredients selected from meat, meat by-products, fish, fish by-products, dairy, dairy by-products, microbial proteins, amino acids, and carbohydrates. Additional ingredients, including other natural and artificial flavors, other palatability-enhancing acids and salts thereof, vitamins and mineral supplements, anti-oxidants, preservatives, inorganic salts, and the like, may also be utilized.

The palatability enhancer can be applied to the kibbles as a dry power via a dusting process, or may be sprayed onto the kibbles as a liquid. Additionally or alternatively, the palatability enhancer may be directly included in the basal formulation. The palatability enhancer is preferably applied in an amount sufficient to contribute from about 0.01 to about 5% by weight of one or more potassium pyrophosphate salts by weight to the pet food composition.

The present invention also includes palatability enhancing compositions utilized in the inventive method. Therefore, according to another aspect of the present invention, palatability enhancing compositions for extruded pet food compositions are provided containing at least one potassium pyrophosphate salt in an amount effective to enhance palatability and at least one ingredient selected from meat products, meat by-products, fish products, fish by-products, dairy products, dairy by-products, sources of microbial proteins, carbohydrates and amino acids.

The present invention also includes extruded pet food compositions coated with the palatability enhancing compositions of the present invention.

The present invention is particularly well suited for topical application to a basal dry pet food kibble that has been coated with fat. Products that utilize the palatability enhancer of the present invention can economically achieve a high degree of palatability in dry pet foods. Such factors are especially important for products that are developed for certain animals, such as domestic cats, that are characteristically finicky in selecting their food.

### DETAILED DESCRIPTION OF THE PREFERRED EMBODIMENTS

The present invention provides palatability enhancer compositions prepared from tetrapotassium pyrophosphate (TKPP) and methods for increasing the palatability of dry pet foods therewith. More specifically, the palatability enhancing compositions and methods relate to one or more potassium pyrophosphate salts derived from TKPP constituting from about 0.01% to about 5% of the finished pet food product.

When dissolved in solution, depending upon pH, TKPP may partially or completely dissociate to form one or more additional species including the free pyrophosphate anion, and mono-, di- and tri-potassium salts thereof, in which, after liquid product has dried on an extruded pet food product, one, two, three or four potassium atoms are replaced with hydrogen atoms. Accordingly, palatability enhancers of the present invention in which the TKPP has been dissolved in solution and permitted to equilibrate are referred to as containing one or more potassium pyrophosphate salts. Potassium pyrophosphate salts also include mixed sodium and potassium salts such as, for example, mono-hydrogen, mono-sodium, di-potassium pyrophosphate. The palatability enhancers can be liquid palatability enhancers or products that are subsequently dried by evaporation, lyophilization, and the like to form a dry product.

The exact ratios of the four pyrophosphate salts to the total pyrophosphate content can be readily determined by one of ordinary skill in the art knowing the final solution pH without undue experimentation by employing the Henderson-Hasselbach equation and using the pKₐ's of the potassium pyrophosphate salts, which are known physical constants.

When dry-blended with other palatability enhancer ingredients the TKPP will not dissociate. TKPP added in dry form to essentially dry palatability enhancer formulations will remain essentially TKPP.

In accordance with this invention, the palatability enhancer is applied to the surface of dry pet food, usually in the form of pellets or kibbles, and may be used in conjunction with either a traditional palatability enhancer or other flavorings. Additionally or alternatively, the palatability enhancer may be directly added to the basal formulation.

Dry pet food generally consists of a nutritionally balanced mixture of proteinaceous and farinaceous materials having a moisture content of less than 15% by weight. Protein-aceous material may include any material having a protein content of at least 15% by weight. Such materials are exemplified by fresh animal tissue such as meat, poultry, and fish tissue; meal derived from animal matter such as fish meal, poultry meal, meat meal, or bone meal, animal proteins such as casein and albumin; vegetable proteins such as soy beans, cotton seed, peanuts, and wheat or corn gluten; dairy products such as whey; and microbial proteins such as brewer's yeast. Farinaceous materials may include any material containing a substantial portion of digestible starch including grains such as corn, wheat, milo, alfalfa, barley, rice, and oats.

In addition to proteinaceous and farinaceous materials, various other ingredients or supplements may be included either in the initial formulation or during one or more subsequent processing steps. These additional constituents include vitamins, minerals, preservatives, emulsifiers, humectants, salts, etc., and are usually included for nutrition, flavor, or processing purposes. Examples of some typical vitamins include vitamin A, vitamin E, vitamin B₁₂, vitamin D₃, riboflavin, and folic acid. Examples of some typical minerals include copper sulfate, calcium iodate, zinc oxide, and ferrous sulfate. Other added ingredients could include materials such as sodium chloride, corn syrup, molasses, and phosphoric acid. However, it should be noted that the dry pet food compositions described herein are not limited to any specific listing of ingredients because any particular food formulation is dependant upon factors such as dietary standards (i.e. the balance of protein, carbohydrates, fat, minerals, and vitamins), target market (e.g. taxonomic family or age of the animal), ease of production, and cost of raw materials.

An example of a well known formulation for dry cat food is as follows (in percent by weight): about 0-70% grain-based meal or flour such as corn, wheat, barley, or rice; about 0-30% animal by-product meal, such as poultry or beef meal; about 0-25% corn gluten meal; about 0-25% fresh animal tissue, such as beef or poultry tissue; about 0-25% soy meal or flour; about 0-10% animal fat; about 0-25% seafood-based meal; about 0-25% fresh fish tissue; about 0-10% high fructose corn syrup; about 0-10% dried molasses; about 0-1.5% phosphoric acid; and about 0-1. 5% citric acid. To this formulation, the following vitamin and mineral supplements might be added: calcium carbonate, potassium chloride, sodium chloride, choline chloride, taurine, zinc oxide, ferrous sulfate, vitamin E, vitamin A, vitamin B₁₂, vitamin D₃, riboflavin, niacin, calcium pantothenate, biotin, thiamine mononitrate, copper sulfate, folic acid, pyroxidine hydrochloride, calcium iodate, and menadione sodium bisulfate complex (vitamin K).

Dry pet food may be prepared by a variety of methods. One such method that is widely used on commercial basis is the cooker-extruder method. In the cooker-extruder method, dry ingredients are first blended together to form an admixture. This admixture is transferred into a steam conditioner where it is sufficiently moistened to become extrudable. The admixture then enters a cooker/extruder where it is cooked at an elevated temperature and pressure and then forced out of the apparatus through a die. This die forms the extruded product into a specific shape. Individual pieces of product are created by periodically slicing off the end of the extruded stream of product. The individual pieces, or kibbles, are then dried in a hot air dryer. Generally, the product is dried until it contains less than about 15 percent moisture, and preferably about 9 to 12 percent moisture. The resulting pellets or kibbles constitute the basal composition to which a coating of the palatability enhancer and/or flavor composition is added.

Coating, as used herein, refers to the topical deposition of the palatability enhancer or flavor composition onto the surface of the basal composition, such as by spraying, dusting, or the like. For example, kibbles of uncoated, extruded basal cat food can be placed into a container such as a tub or coating drum for mixing. A fat, such as lard or tallow, is heated and then sprayed onto the cat food in any convenient manner to obtain a coating of the kibbles. The coating need not be a continuous layer, but preferably is uniform. After the fat cools, a flavor may be applied as either a dry power or a liquid while the product is mixing. A liquid flavor is typically sprayed on while a dry flavor is typically dusted on, preferably through a mesh screen to make the application more uniform on the kibbles. Alternatively, a flavor could be mixed with the fat and applied concurrently. Note that multiple coatings may be applied to achieve uniformity of the coating.

The palatability enhancers of the present invention are prepared from tetra-potassium pyrophosphate (TKPP), a compound that is commercially available as a dry powder, granules, or an encapsulated form. A mixed sodium and potassium salt can be used as well. The TKPP may be combined with other palatability-enhancing ingredients such as animal products and by-products, fish products and by-products, dairy products and by-products, microbial proteins, amino acids, carbohydrates, and the like.

For purposes of the present invention, “animal” products and by-products are defined as including meat products and by-products from animal species other than fish. Examples of animal products and by-products that can be used include, but are not limited to, products and by-products derived from beef, pork, sheep or lamb, poultry, duck, and the like. Specific by-products that can be used include, but are not limited to, the offal and organ tissue of cattle, swine, sheep, poultry, and the like, such as the liver, heart, kidneys, brain, connective tissues, bones, cartilage, tendons, and the like.

Examples of fish products and by-products that can be used include, but are not limited to, products and by-products derived from tuna, salmon, cod, whitefish, shrimp, and the like. Specific examples of by-products that can be used include, but are not limited to, offal such as the skins, heads, internal organs, bones, cartilage, scales, and the like.

Examples of dairy products and by-products that can be used include, but are not limited to, products and by-products derived from milk protein, cheese, eggs, and the like. Specific examples of by-products that can be used include, for example, whey.

Examples of microbial proteins that can be used include, but are not limited to, brewer's yeast, baker's yeast, and the like. Examples of vegetable proteins that can be used include, but are not limited to, corn gluten, soy flour, soy protein, hydrolyzed vegetable protein (HVP), and the like. Examples of amino acids that can be used include, but are not limited to, alanine, glycine, cysteine, lysine, and the like. Examples of carbohydrates that can be used include, but are not limited to, glucose, fructose, xylose, starch hydrolysates, and the like.

Other palatability enhancing acids and salts thereof may also be used, including sodium, calcium and magnesium salts of pyrophosphate, phosphoric acid and the sodium, potassium, calcium and magnesium salts thereof, polyphosphoric acid and the sodium, calcium and magnesium salts thereof, organic acids such as citric, tartaric, fumaric, lactic, acetic, formic and hexamic acids and the sodium, potassium, calcium and magnesium salts thereof. Other suitable ingredients include vitamin and mineral supplements, such as vitamin A, vitamin E, anti-oxidants and preservatives, such as butylated hydroxyanisole (BHA), butylated hydroxytoluene (BHT), tert-Butylhydroquinone (TBHQ), tocopherol, and rosemary extract, other natural and artificial flavors such as dairy flavor, roast chicken flavor, and the like.

The palatability enhancers of the present invention contain from about 0.1% to 99% by weight of one or more potassium pyrophosphate salts. Preferably, the palatability enhancers are formulated so that the one or more potassium pyrophosphate salts constitute from about 0.01% to about 5% by weight of the finished pet food product. More preferably, the palatability enhancers are formulated so that the one or more potassium pyrophosphate salts constitute from about 0.05% to about 2% by weight of the finished pet food product. It should be understood that the exact composition of the palatability enhancer, as well as its relative percent weight of the finished product, are not limited to the aforementioned examples and could be adjusted based upon manufacturing, marketing, or economic factors.

Among the preferred palatability enhancers according to the present invention are palatability enhancers containing from about 5 to about 99 wt.% of one or more products or by-products selected from animal products, animal by-products, fish products, fish by-products, dairy products and dairy by-products. Preferred products and by-products that may be present alone or in combination include products and by-products of beef, pork, lamb, poultry, fish, and the like. A product or by-product level between about 20 and about 70 wt.% is preferred.

Among the same or other preferred palatability enhancers according to the present invention are palatability enhancers containing from about 0.01 to about 10 wt.% of one or more amino acids. Preferred amino acids that may be present alone or in combination include alamine, glycine, lysine, and the like. An amino acid level between about 0.1 and about 4 wt.% is preferred.

Among the same or other preferred palatability enhancers according to the present invention are palatability enhancers containing from about 5 to about 70 wt.% of one or more microbial proteins. Preferred sources of microbial proteins that may be present alone or in combination include brewer's yeast and the like. A microbial protein level between about 10 and about 40 wt.% is preferred.

Among the same or other preferred palatability enhancers according to the present invention are palatability enhancers containing from about 0.01 to about 50 wt.% of one or more carbohydrates. A carbohydrate level between about 1.0 and about 30 wt.% is preferred.

One example of a preferred formulation has a solids content of from about 10 to about 40 wt.% of one or more potassium pyrophosphate salts; from about 30 to about 60 wt% of one or more products or by products selected from animal products, animal by-products, fish products, fish by-products, dairy products and dairy by-products; from about 25 to about 35 wt.% of one or more sources of microbial proteins; from about 2 to about 4 wt.% of one or more amino acids; and from about 0.5 to about 60 wt% of one or more carbohydrates.

Dry formulations have a solids content of about 96 wt%. Liquid formulations may be diluted to a total solids content of about 30 wt% with water and preferably to a solids content no less than about 50 wt%. The water content may also be supplied by moisture-containing or liquid components, the amounts of which are selected by well-known techniques to maintain the solids content of the product.

Liquid formulations according to the present invention have a pH between about 2 and about 9. Preferred liquid formulations have a pH between about 2 and about 3.

In one preferred embodiment of the present invention, a dry palatability enhancer is made by blending TKPP with other dry ingredients in a tumbler until a homogeneous mixture is formed. The palatability enhancer is then topically applied to a basal food product that has been previously coated with fat. The dry palatability enhancer is dusted onto the product in a tumbler to achieve a uniform coating. The final product contains about 0.02 to about 5% of TKPP by weight.

In another preferred embodiment, a liquid palatability enhancer is made by mixing a solution of TKPP and water with other wet and dry ingredients in a mixer until a homogenous mixture is formed. The palatability enhancer is then topically applied to a basal food product that has been previously coated with fat. The wet palatability enhancer is sprayed onto the product so as to achieve a uniform coating and permitted to dry. The final product contains about 0.3% of potassium pyrophosphate salts.

In yet another preferred embodiment of the present invention, a dry palatability enhancer is made by mixing a solution of wet and dry ingredients in a mixer until a homogenous mixture is formed. The mixture is lyophilized to form a dry, powdery product that is then blended with TKPP and other dry ingredients in a tumbler until a homogeneous mixture is formed. The palatability enhancer is then topically applied to a basal food product in a tumbler to achieve a uniform coating. The final product contains about 0.5% of TKPP by weight.

The palatability enhancers of the present invention may be used in other pat foods and animal foods for species other than cats without regard to the protein content, which varies according to species, breeding status and age, among other factors. The palatability enhancers may thus be applied to extruded dog food compositions, and to extruded food compositions for other animals, including research animals and livestock.

### EXAMPLES

The following examples illustrate the effect of potassium pyrophosphate salts as a palatability enhancer for food for domestic house cats. The test data was obtained by a standard two-bowl test method in which a panel of approximately 20 cats was each presented two different food formulations. The food in each bowl was weighed prior to presenting it to the cat and, when presented, the bowls were positioned side-by-side. The placement of the bowls was reversed daily. Once the food was offered to the cat, the cat was allowed free choice in eating from either bowl for up to 16 hours. After the bowls were removed, the remaining food from each bowl was individually weighed and the difference in weight was recorded as the amount consumed. The amount of food consumed from each of the two side-by-side bowls was then compared to determine the Consumption Ratio (C.R.).

All of the food presented to the cats was composed of kibble, fat, and a one or more ingredients selected from (a) 30-50% animal digest, such as pork, fish, or poultry, (b) 10-50% brewer's yeast, or (c) 0.1-5% amino acid. For comparison, some of the food also contained either tetrapotassium pyrophosphate or tetrasodium pyrophosphate as a palatability enhancer.

### Example 1

This Example illustrates the effect of adding tetrapotassium pyrophosphate to a traditional liquid flavor enhancer. In Test 1, a palatability enhancer made from poultry liquid digest without tetrapotassium pyrophosphate is compared to a palatability enhancer made from poultry liquid digest with potassium pyrophosphate salts made from tetrapotassium pyrophosphate. In Test 2, a palatability enhancer containing potassium pyrophosphate salts made from 0.1 wt% tetrapotassium pyrophosphate is compared to a palatability enhancer containing potassium pyrophosphate salts made from 0.3 wt% tetrapotassium pyrophosphate.

In Test 1, Variable A1 consists of food coated with 3.0% by weight of poultry liquid digest while Variable B1 is food coated with 3.3% by weight of poultry liquid digest containing 0.3% by weight of potassium pyrophosphate salts. The results indicate that B1 is preferred to A1 with a consumption ratio of 2.82:1. These results are summarized in Table 1.

In Test 2, Variable A2 is food coated with 3.1 wt% poultry liquid digest containing 0.1 wt% potassium pyrophosphate salts and Variable B2 is food coated with 3.3 wt% poultry liquid digest containing 0.3 wt% potassium pyrophosphate salts. The results indicate that B2 is preferred to A2 with a consumption ratio of 1.63:1. The results are summarized in Table 1.

TABLE 1

| | | | Relative | | No. of Cats |
|---|---|---|---|---|---|
| | | TKPP | Consumption | | Tested |
| Test | Variable | (%) | (%) | C.R. | (Samples) |
| 1 | A1 | 0.0 | 26.2 | 2.82 | 21 |
| | B1 | 0.3 | 73.8 | | |
| 2 | A2 | 0.1 | 38.0 | 1.63 | 21 |
| | B2 | 0.3 | 62.0 | | |

### Example 2

This Example illustrates the effect of adding tetrapotassium pyrophosphate to a traditional dry flavor enhancer. In Test 3, a palatability enhancer dry blended from poultry dry digest without tetrapotassium pyrophosphate is compared to a palatability enhancer dry blended from poultry dry digest with tetrapotassium pyrophosphate. In Test 4, a dry blended palatability enhancer containing 0.2 wt% tetrapotassium pyrophosphate is compared to a dry blended palatability enhancer containing 0.5 wt% tetrapotassium pyrophosphate.

In Test 3, Variable A3 consists of food coated with 2.0% by weight of poultry dry digest and Variable B3 is coated with 2.5% by weight of poultry dry digest that contains 0.5% by weight of dry tetrapotassium pyrophosphate. The results indicate that B3 is preferred to A3 with a consumption ratio of 2.10:1. These results are summarized in Table 2.

In Test 4, Variable A4 consists of food coated with 2.2% by weight of poultry dry digest containing 0.2% by weight of tetrapotassium pyrophosphate and Variable B4 is coated with 2.5% by weight of poultry dry digest that was dry blended with 0. 5% by weight of tetrapotassium pyrophosphate. The results indicate that B4 is preferred to A4 with a consumption ratio of 1.32:1. These results are summarized in Table 2.

TABLE 2

| | | | Relative | | 0 No. of Cats |
|---|---|---|---|---|---|
| | | TKPP | Consumption | | Tested |
| Test | Variable | (%) | (%) | C.R. | (Samples) |
| 3 | A3 | 0.0 | 32.3 | 2.10 | 21 |
| | B3 | 0.5 | 67.7 | | |
| 4 | A4 | 0.2 | 43.1 | 1.32 | 18 |
| | B4 | 0.5 | 56.9 | | |

The present invention thus provides potassium pyrophosphate salts products for enhancing pet food palatability. The present invention also provides a method for the preparation of pet food products containing the disclosed palatability enhancers.

The foregoing examples and description of the preferred embodiment should be taken as illustrating, rather than as limiting, the present invention as defined by the claims. As will be readily appreciated, numerous combinations of the features set forth above can be utilized without departing from the present invention as set forth in the claims. Such variations are not regarded as a departure from the spirit and scope of the invention, and all such modifications are intended to be included within the scope of the following claims.

1. A method of increasing the palatability of an extruded pet food product comprising applying a palatability enhancing composition including at least one potassium pyrophosphate salt to said extruded pet food product.

2. The method according to claim 1, wherein said palatability enhancing composition comprises from about 0.1 to about 99% by weight of at least one potassium pyrophosphate salt.

3. The method according to claim 1, wherein said palatability enhancing composition is applied in a quantity sufficient to contribute from about 0.01 to about 5% by weight of at least one potassium pyrophosphate salt to said pet food product.

4. The method according to claim 1, wherein said palatability enhancing composition further comprises at least one ingredient selected from the group consisting of animal products, animal by-products, fish products, fish by-products, dairy products, dairy by-products, sources of microbial proteins, vegetable proteins, carbohydrates and amino acids.

5. The method according to claim 1, wherein said palatability enhancing composition is a liquid, and said applying step comprises spraying said palatability enhancing composition onto said extruded pet food product.

6. The method according to claim 1, wherein said palatability enhancing composition is dry, and said applying step comprises dusting said palatability enhancing composition onto said extruded pet food product.

7. The method according to claim 6, wherein potassium pyrophosphate salt content of said palatability composition consists essentially of tetra-potassium pyrophosphate.

8. The method according to claim 1, wherein said extruded pet food composition is a dry cat food.

9. The method according to claim 1, wherein said extruded pet food composition is a semi-dry cat food.

10. The method according to claim 1, wherein said palatability enhancing composition is added to said pet food product prior to extrusion.

11. A palatability enhancing composition for extruded pet food, said composition comprising at least one potassium pyrophosphate salt in an amount effective to enhance palatability and at least one ingredient selected from the group consisting of animal products, animal by-products, fish products, fish by-products, dairy products, dairy by-products, sources of microbial proteins, carbohydrates and amino acids.

12. The composition of claim 11, wherein said composition is dry, and the potassium pyrophosphate salt content of said composition consists essentially of tetrapotassium pyrophosphate.

13. The composition of claim 11, wherein said composition is liquid.

14. An extruded pet food composition comprising a basal composition coated after extrusion with a palatability enhancing quantity of the composition of claim 11.

15. The pet food composition of claim 14, consisting of a dry cat food.

16. The pet food composition of claim 14, consisting of a semi-dry cat food.

17. The pet food composition of claim 14, wherein said palatability enhancing composition is dusted thereon in dry form.

18. The pet food composition of claim 14, wherein said palatability enhancing composition is sprayed thereon in liquid form.

19. An extruded pet food composition comprising a basal composition mixed prior to extrusion with a palatability enhancing quantity of the composition of claim 11.
